(19) United States
(12) Patent Application Publication
(10) Pub. No.: US 2026/0261414 A1
(43) Pub. Date: Sep. 3, 2026

(54) INTRAORAL SCANNING DEVICE WITH COMMUNICATION PROTECTION AND RELATED METHOD

(71) Applicant: 3SHAPE A/S, Copenhagen K (DK)

(72) Inventor: Anders Robert JELLINGGAARD, Copenhagen K (DK)

(73) Assignee: 3SHAPE A/S, Copenhagen K (DK)

(21) Appl. No.: 18/875,320

(22) PCT Filed: Jun. 16, 2023
(86) PCT No.: PCT/EP2023/066207

§ 371 Date: Dec. 16, 2024

(30) Foreign Application Priority Data
Jun. 17, 2022 (EP) 22179518.0

(51) Int. Cl. H04L 9/08; H04L 9/32

(52) U.S. Cl. CPC H04L 9/088; H04L 9/3247

(57) ABSTRACT

Embodiments can relate to an intraoral scanning device having a processing unit configured to process intraoral scan data of a patient and provide 2D image data and/or 3D image data. The device can include a memory unit and a wireless interface. The processing unit is configured to receive a session request for a session via the wireless interface; obtain and/or store a session key; and encrypt the session key. The processing unit is configured to send a session response; and receive session data in the session via the wireless interface. Embodiments can also relate to a method for communication of a handheld intraoral scanning. The method involves receiving a session request for a session via the wireless interface; obtaining and/or storing a session key; and encrypting the session key. The method involves sending the encrypted session key; and receiving session data in the session via the wireless interface.

### FIELD

The present disclosure relates to an intraoral scanning device with communication protection and related method, and in particular to an intraoral scanning device for communicating securely with accessory devices/systems and related method.

### BACKGROUND

The functionality of an intraoral scanning device becomes increasingly advanced. Wireless communication between an intraoral scanning device and external devices, such as a clinic computer, a scan computer, a dental software on a computer, and a customization computer, has evolved. Typically, a wireless communication interface of an intraoral scanning device uses open standard-based interface. However, this poses many challenges in terms of security. An intraoral scanning device may assume any incoming data as legitimate and may allow memory to be written or changed by an unauthorized party. Any such attacks may result in a malfunction of the intraoral scanning device, or a battery exhaustion attack.

However, an intraoral scanning device is a small device with strict constraints in terms of computational power, memory space, etc. Therefore, a device communicating with an intraoral scanning device cannot use an off-the-shelf security algorithm and protocol, at the risk of e.g. depleting the intraoral scanning device battery or degrading functions of the intraoral scanning device rendering the intraoral scanning quasi-useless.

Present intraoral scanning devices are part of a service infrastructure which includes communication between intraoral scanning devices, scan software for a specific service, and the provider of the service. The service could for example include manufacture of an aligner, a retainer, a crown, an implant, a bracer, a nightguard etc. For improving the usability of such an infrastructure for the dentist, minimal interaction between the infrastructure and the dentist is needed. One way of achieving this is by applying wireless communication between the intraoral scanning device and an external computer that is connected to a server that can forward the intraoral scan data to a service provider. Scan data of a patient can be characterized as being personal information, and therefore, there is a need for minimizing any risk of a third party stealing or corrupting the at least scan data. The scan data is characterized as personal information, and in some situations, other type of personal information is associated with the scan data, such as age, gender, location address, personal security number etc. In this example, a demand for improving the security of the wireless communication in the service infrastructure is needed.

### SUMMARY

An aspect of the present disclosure is to provide an intraoral scanning device with reduced risk of a third party accessing any part of the intraoral scanning device.

A further aspect of the present disclosure is to provide an intraoral scanning device, and a method which seeks to mitigate, alleviate, or eliminate one or more of the above-identified deficiencies in the art and disadvantages singly or in any combination.

Yet another aspect of the present disclosure is to improve security of an intraoral scanning device. Security comprises in assessing threats, vulnerabilities and attacks and developing appropriate safeguards and countermeasures to protect against threats and attacks. The present disclosure relates to an intraoral scanning device comprising a processing unit configured to process intraoral scan data of a patient and provide 2D image data and/or 3D image data.

According to the aspects, an intraoral scanning device for acquiring intraoral scan data from a three-dimensional dental object during a scanning session is disclosed. The intraoral scanning device may comprise a processing unit configured to process intraoral scan data of a patient and provide 2D image data and/or 3D image data; a memory; and a wireless interface configured for transmitting the 2D image data and/or the 3D image data. Furthermore, the processing unit may be configured to receive a session request for a session via the wireless interface; obtain and store a session key; sign the session key by an intraoral scanning device key, and wherein the intraoral scanning device key may be stored in a permanent memory of the intraoral scanning device. The processing unit may be configured to send a session response that may comprise the signed session key and to receive session data in the session via the wireless interface.

According to the aspects, an intraoral scanning device for acquiring intraoral scan data from a three-dimensional dental object during a scanning session is disclosed. The intraoral scanning device may comprise a processing unit configured to process intraoral scan data of a patient and provide 2D image data and/or 3D image data; a memory; and a wireless interface configured for transmitting the 2D image data and/or the 3D image data. Furthermore, the processing unit may be configured to receive a session request for a session via the wireless interface; obtain and store a session key; encrypt the session key based on an intraoral scanning device key, and wherein the intraoral scanning device key may be stored in a permanent memory of the intraoral scanning device. The processing unit may be configured to send a session response that may comprise the encrypted session key and to receive session data in the session via the wireless interface.

According to the aspects, an intraoral scanning device for acquiring intraoral scan data from a three-dimensional dental object during a scan session is disclosed. The intraoral scanning device may comprise a processing unit configured to process intraoral scan data of a patient and provide 2D image data and/or 3D image data; a memory; and a wireless interface configured for transmitting the 2D image data and/or the 3D image data. Furthermore, the wireless interface may be configured to transmit a session request to the processing unit. Furthermore, the processing unit may be configured to obtain and store a session key and to encrypt the session key based on an intraoral scanning device key, that may be stored in a permanent memory of the intraoral scanning device. The processing unit may be further configured to send a session response that may comprise the encrypted session key and receive session data in the session via the wireless interface.

According to the aspects, a method for communication with an intraoral scanning device for acquiring intraoral scan data from a three-dimensional dental object during a scanning session is disclosed. The method may comprise a processing unit configured to process intraoral scan data of a patient and provide 2D image data and/or 3D image data, a memory unit, and a wireless interface. Furthermore, the method may comprise receiving a session request for a session via the wireless interface, obtaining and storing a session key, and signing the session key by an intraoral scanning device key, wherein the intraoral scanning device key may be stored in a permanent memory of the intraoral scanning device. Furthermore, the method may comprise sending a session response comprising the signed session key, and receiving session data in the session via the wireless interface.

According to the aspects, a method for communication with an intraoral scanning device for acquiring intraoral scan data from a three-dimensional dental object during a scanning session is disclosed. The method may comprise a processing unit configured to process intraoral scan data of a patient and provide 2D image data and/or 3D image data, a memory unit, and a wireless interface. Furthermore, the method may comprise receiving a session request for a session via the wireless interface, obtaining and storing a session key, and encrypting the session key based on an intraoral scanning device key, wherein the intraoral scanning device key may be stored in a permanent memory of the intraoral scanning device. Furthermore, the method may comprise sending a session response comprising the encrypted session key, and receiving session data in the session via the wireless interface.

According to the aspects, a method for communication with an intraoral scanning device for acquiring intraoral scan data from a three-dimensional dental object during a scanning session is disclosed. The method may comprise a processing unit configured to process intraoral scan data of a patient and provide 2D image data and/or 3D image data, a memory unit, and a wireless interface. Furthermore, the method may comprise transmitting a session request to the processing unit, obtaining and storing a session key and encrypting the session key based on an intraoral scanning device key, wherein the intraoral scanning device key may be stored in a permanent memory of the intraoral scanning device. Furthermore, the method may comprise sending a session response comprising the encrypted session key and receiving session data in the session via the wireless interface.

An intraoral scanning device is in a scanning session when it is being used intentionally, such as for scanning of an oral cavity of a patient.

The session key may be signed before being encrypted based on the intraoral scanning device key, and where the session response includes the encrypted session key. The processing unit may be configured to verify integrity of the session data. The encryption of the session key provides an additional layer of security when distributing session key in between the intraoral scanning device and an external device(s).

The intraoral scanning device comprises a processing unit. The processing unit may be configured to process intraoral scan data of a patient and provide 2D image data and/or 3D image data. The 2D image data and/or 3D image data may include information about the anatomy of the oral cavity of the patient, such as teeth, gingival, bone level, and/or information about diagnostic indicators such as caries, bone loss, gingivitis, gingiva recession, periodontitis, bone loss, cracks, and occlusion.

The 2D image data and/or the 3D image data may be image data configured to be visualizable on a display in a 2D or a 3D manner, respectively.

The session data may comprise customization data, and the customization data may include, for example, settings of a color image sensor of an intraoral scanning device. An intraoral scanning device may include a color image sensor, such as an RGB image sensor where the customization data may include information about different color areas to be deactivated and/or activated during at least a scanning session. Thus, the customization data may relate to which color areas of the RBG image sensor should be activated or deactivated during a scanning session. An intraoral scanning device may include a monochromatic image sensor and colored light emitting diodes, and in this example, the customization data may include information about which of the different colored light emitting diodes should be deactivated and/or activated during a scanning session. Thus, the customization data may include information that relates to which colored light emitting diodes should be activated or deactivated during a scanning session. A colored light emitting diode may be configured to emit light with a color, such as blue, red, green etc. In another example, the intraoral scanning device could include one or more near-infrared light emitting diodes which also can be set to be activated and/or deactivated during a scanning session by the customization data. The customization data may include setting data, such as power management settings, configuration of a user interface of the intraoral scanning device and/or settings of an optical unit of the intraoral scanning device

The optical unit may include one or more light projectors, one or more optical components, and one or more image sensors.

The intraoral scanning device may comprise a processing unit, a memory unit and a wireless interface. The wireless interface may comprise a wireless transceiver, e.g. configured for wireless communication at frequencies in the range from 2.4 to 2.5 GHz, 2.4 GHz to 5 GHz, or about 2.4 GHz or about 5 GHz.

The processing unit may be configured to receive a session request for a session via the wireless interface. The processing unit may be configured to verify the session request, such as authenticate the sender of the session request, e.g. a client device or a server device. It may be envisaged that the intraoral scanning device and the sender of the session request have pre-established authenticated connection which thus permits the session request to be authenticated by the intraoral scanning device. The session request may comprise a digital signature enabling authentication of the session request.

In one or more exemplary intraoral scanning devices, the session request comprises a digital signature. The processing unit may be configured to verify integrity of the session request, e.g. by verifying the digital signature. For example, a verifier of the processing unit may be configured to verify the digital signature. The processing unit verifies the digital signature using a signature verification function and a public key of a sender that has generated the digital signature and included the digital signature in the session request. If the intraoral scanning device/processing unit determines that the digital signature is not successfully verified using the alleged public key of a sender, the intraoral scanning device disregards the session request and terminates the session. This may provide the advantage that the intraoral scanning device rejects session requests from unauthenticated parties, thereby reducing the risk of or limit the effects of a battery exhaustion attack.

The intraoral scanning device may be paired with a sender of the session request prior to receipt of the session request. In the pairing, the intraoral scanning device and the sending/client device may have exchanged one or more of intraoral scanning device identifier, sender identifier, session key/identifier, etc.

The processing unit is configured to obtain and/or store a session key; and encrypt the session key, optionally based on an intraoral scanning device key. The session key may be a symmetric key. A symmetric session key may provide a lightweight processing of the security algorithms on the processing unit, such as lightweight encryption, lightweight decryption, lightweight integrity protection, etc.

The processing unit is configured to obtain the session key, and to obtain the session key may comprise to generate the session key, e.g. as a random or pseudo-random number. Thus, the intraoral scanning device and/or the processing unit may comprise a number generator, e.g. configured to generate a random or pseudo-random number. By using a unique session key or session key from a large number of available session keys, the processing power requirements in the intraoral scanning device may be reduced. Further, simple encryption is facilitated, and replay-attacks are prevented.

The intraoral scanning device key may be a symmetric key or a public key of a private-public key pair. The intraoral scanning device key may be stored in a permanent memory of the intraoral scanning device, e.g. during manufacture or during a customization session.

The processing unit is configured to send a session response in response to the session request. The session response may comprise the encrypted session key. The session response may comprise an intraoral scanning device identifier and/or the session key. Thus, the processing unit may be configured to send an intraoral scanning device identifier and/or the session key in the session response. A session response comprising an intraoral scanning device identifier may enable the sender of the session request to obtain the intraoral scanning device key, either from a database or by requesting the intraoral scanning device key from the manufacturer, which in turn enables the sender of the session request to decrypt the session key and use the session key when sending session data to the intraoral scanning device.

The intraoral scanning device disclosed herein has the advantage of verifying integrity of received data, detecting any alteration and disregard altered data. The intraoral scanning device disclosed herein has the advantage to open a session only with authenticated parties, such as an authenticated customization device, an authenticated accessory device, an authenticated external devices and/or an authenticated server.

The processing unit is configured to receive session data in the session via the wireless interface. The processing unit may be configured to verify integrity of the session data. The session data may comprise a message authentication code. To verify integrity of the session data may comprise to verify the message authentication code, e.g. with the stored session key. The session data may comprise a digital signature. To verify integrity of the session data may comprise verifying the digital signature.

The processing unit may be configured to terminate the session if integrity of the session data is corrupted, i.e. verification of the integrity fails.

The processing unit may be configured to decrypt the session data with the session key. The processing unit may be configured to store at least part of decrypted session data in the memory unit. The processing unit may be configured to terminate the session if decryption of the session data fails. The session data may comprise customization data, intraoral scanning device operating parameters, and/or firmware data.

The intraoral scanning device operating parameters may corresponds to settings of the handheld intraoral scanning device that involves settings of the image sensor, light projector, the wireless interface, a scan sequence of the handheld intraoral scanning device. Etc. The scan sequence corresponds to a scanning of a patient's jaws with the handheld intraoral scanning device, while in real-time the handheld intraoral scanning device is configured to determine and transmit the 3D image data based on the intraoral scan data acquired by the image sensor of the handheld intraoral scanning device during the scan sequence.

Furthermore, the intraoral scanning device operating parameters relates to power management settings, configuration of a user interface of the intraoral scanning device and/or settings of an optical unit of the intraoral scanning device.

The handheld intraoral scanning device may include a user interface which may include at least a touch sensor, at least a touch button, at least a light emitting diode, a haptic sensor, and/or an accelerometer. The handheld intraoral scanning device may include a motion sensor which is configured to sense the motion of the handheld intraoral scanning device. The handheld intraoral scanning device is configured to communicate wirelessly with an external device that is connected to a display. A cursor on the display may be moved around based on motion signals provided by the motion sensor to the external device. The user is able to navigate the cursor on the display by moving the handheld intraoral scanning device. The session data may include settings update that relates to the motion sensor of the handheld intraoral scanning device, and the customization data may include settings for customizing a user interface of the handheld intraoral scanning device which may involve a graphical setup of a graphical user interface on the display. For example, when the handheld intraoral scanning device connects to the external device, the handheld intraoral scanning device forwards a customization package to the external device via the wireless interface, and the external device is then configured to change the graphical setup based on the customization package. The customization package may be updated by the customization data provided by the session data.

The firmware data may include updates to the handheld intraoral scanning device that improves the functionality and features of the device.

The processing unit may be configured to process intraoral scan data of a patient and provide 2D image data and/or 3D image data according to the received session data. Thus, a sender of the session request may control operation of the intraoral scanning device, either by sending customization data, intraoral scanning device operating parameters, and/or firmware data. The disclosed intraoral scanning device and method prevents unauthorized access or control of an intraoral scanning device.

The session data may be relevant for providing image data with improved quality or with more features. In this example, the session data may be relevant for the optical unit or with firmware updates that improves the processing of the intraoral scan data into the image data.

The intraoral scanning device being able to send a session response may be scheduled for a specific time on a day where the intraoral scanning device will not be used. The scheduling may be determined by the processing unit based on historical usage time of the intraoral scanning device and a machine learning model. The machine learning model receives timestamps from a clock in the intraoral scanning device and input information about when the intraoral scanning device is being used in a scanning session. The machine learning model includes a training data set which includes historical usage time of the intraoral scanning device being in the scanning session. Based on the machine learning model and a timestamp defining the time of the day the processing unit will know when to be set into a requested mode if receiving a mode request. The advantage of the scheduling is that a session request will not interfere the work of the dentist with the intraoral scanning device. Furthermore, the processing unit may be configured to do time consuming updates within specific time-period(s). For example, an update which last more than 30 mins will automatically be planned to be performed in a time-period of more than 30 mins where the intraoral scanning device will not be used, such as outside the working hours or during a break of the dentist/clinic. In other words, the processing unit is configured to plan an update based on an estimated time for installing the update to a firmware of the memory unit.

The processing unit may be configured to send a session response if a timestamp is within a time-period. The timestamp is generated by a clock of the intraoral scanning device and received by the processing unit.

The processing unit may include a machine learning model that includes a training data set which includes historical data the relates to usage time of the intraoral scanning device being in a scanning session, and wherein the machine learning model receives a timestamp from a clock in the intraoral scanning device and input information about when the intraoral scanning device is being used in a scanning session, and the processing unit may then be configured to send a session response if the machine learning model outputs a trigger that allows the processing unit to send the session response.

The session data may relate to optical data that are relevant for the optical unit, for processing intraoral scan data, and for providing image data. The optical data may include settings of the light projector(s), the image sensor(s), the motor for the focus lens or firmware/settings for providing trigonometry calculation that includes the emitted light from the light projector(s) and the reflected light received by the image sensor(s). Furthermore, the optical data may include modifications, updates or a new computer-implemented method for processing the intraoral scanning data into 2D image data and/or 3D image data.

The session request corresponds to an optical session request that are relevant for transmitting session data that relates to optical data.

As used herein, the term “intraoral scanning device” refers to a device configured to conduct a scan inside the oral cavity of a patient, or a part thereof, or parts thereof, such as a tooth, teeth, gingiva, etc., or to obtain a 2D image data and/or 3D image data of the oral cavity of a patient or parts thereof, such as a tooth, teeth and/or gingiva, etc. the intraoral scanning device may be an intraoral scanner that is fully or partly inserted in the oral cavity of a patient, such as a wireless intraoral handheld scanner.

Client device for secure intraoral scanning device communication:

An aspect of the present disclosure to provide a client device, and a method which seeks to mitigate, alleviate, or eliminate one or more of the above-identified deficiencies in the art and disadvantages singly or in any combination.

A further aspect of the present disclosure is to improve security in wireless communication with an intraoral scanning device that protects the intraoral scanning device against potential attacks, such as an improved client device, and a method of communication with an intraoral scanning device that improves security thereof.

According to the aspects, a client device for intraoral scanning device communication is disclosed. The client device may comprise a processing unit, a memory unit, and a wireless interface configured to receive 2D image data and/or 3D image data from an intraoral scanning device. The processing unit may be configured to send a session request for a session to the intraoral scanning device via the wireless interface, receive a session response from the intraoral scanning device via the wireless interface, the session response comprising an intraoral scanning device identifier. Furthermore, the processing unit may be configured to obtain a session key based on the session response. Additionally, the processing unit may be configured to determine intraoral scanning device data, generate session data based on the session key and the intraoral scanning device data, and send the session data to the intraoral scanning device via the wireless interface.

According to the aspects, a client device for intraoral scanning device communication is disclosed. The client device may comprise a processing unit, a memory unit, and a wireless interface configured to receive 2D image data and/or 3D image data from an intraoral scanning device. The processing unit may be configured to send a session request for a session to the intraoral scanning device via the wireless interface, receive a session response from the intraoral scanning device via the wireless interface, the session response comprising an intraoral scanning device identifier. Furthermore, the processing unit may be configured to obtain a session key based on the session response, wherein to obtain a session key comprises to establish a connection to a session key generator via the wireless interface, to send a session key request to the session key generator via the wireless interface, the session key request comprising the intraoral scanning device identifier, to receive a session key response from the session key apparatus via the wireless interface, and to determine the session key based on the session key response. Additionally, the processing unit may be configured to determine intraoral scanning device data, generate session data based on the session key and the intraoral scanning device data, and send the session data to the intraoral scanning device via the wireless interface.

According to the aspect, a method, performed in a client device, for intraoral scanning device communication, the client device comprising a processing unit, a memory unit and a wireless interface configured to receive 2D image data and/or 3D image date from an intraoral scanning device. The method may comprise sending a session request for a session to the intraoral scanning device via the wireless interface, receiving a session response via the wireless interface, obtaining a session key based on the session response, wherein obtaining a session key comprises establishing a connection to a session key apparatus, sending a session key request to the session key apparatus, receiving a session key response from the session key apparatus, and determining the session key based on the session key response. Furthermore, the method may comprise determining intraoral scanning device data, generating session data based on the session key and the intraoral scanning device data, and sending the session data to the intraoral scanning device via the wireless interface.

The intraoral scanning device is a handheld scanning device for scanning inside an oral cavity of a patient. The intraoral scanning device differs from other type of teeth scanning device in that the intraoral scanning device is a handheld scanning device which can easily be handled by one hand by a user, and which has now wired connection to any external device during scanning of an inside of an oral cavity of a patient. Therefore, the only attack which an intraoral scanning device may experience is via the wireless interface.

The method and the intraoral scanning device as disclosed provide secure configuration of the intraoral scanning device, such as secure access to the memory of the intraoral scanning device. It is an advantage of the present disclosure that the intraoral scanning device can only be configured or updated by authorized parties. The disclosed intraoral thus has the advantage of detecting and preventing any modification by unauthorized parties. The intraoral scanning device disclosed herein is advantageously protected against attacks such as spoofing attacks, man-in-the-middle attacks, and/or replay-attacks.

The intraoral scanning device is the key element in providing the needed level of security in wireless communication in a service infrastructure which at least includes the intraoral scanning device and a scan computer or a dental software installed on a computer. It would not be possible for a third party to attack the wireless communication as this person needs to have the intraoral scanning device physically in its hand. It would not even be enough to have access to the scan computer or the dental software.

The method and the client device as disclosed provide a secure communication from the client device to the intraoral scanning device, such as provide to the client device a secure and/or authorized access to the memory of the intraoral scanning device. It is an advantage of the present disclosure that the communication between the client device and the intraoral scanning device is protected against any action or at least some actions from undesired parties. The disclosed client device thus has the advantage of allowing the intraoral scanning device to detect any modification by unauthorized parties. The client device provides a secure communication adapted to the intraoral scanning device, which in turn is able to communicate securely with legitimate parties such as the client device and to counterstrike attacks such as spoofing attacks, man-in-the-middle attacks, and/or replay-attacks.

The method as disclosed herein provides a secure configuration and/or update of an intraoral scanning device.

The present disclosure provides improved security of communication performed between the client device and an intraoral scanning device. Security comprises assessing threats, vulnerabilities and attacks and developing appropriate safeguards and countermeasures to protect against threats and attacks. The present disclosure provides an intraoral scanning device comprising a processing unit configured to process intraoral scan data of a patient and provide 2D image data and/or 3D image data. The 2D image data and/or 3D image data may include information about the anatomy of the oral cavity of the patient, such as teeth, gingival, bone level, and/or information about diagnostic indicators such as caries, bone loss, gingivitis, gingiva recession, periodontitis, bone loss, cracks, and occlusion.

The processing unit may be configured to obtain a session key which comprises to establish a connection to a session key apparatus via the wireless interface, to send a session key request to the session key apparatus via the wireless interface, the session key request comprising the intraoral scanning device identifier, to receive a session key response from the session key apparatus via the wireless interface, and to determine the session key based on the session key response.

The processing unit may be configured to obtain a session key which comprises validating the intraoral scanning device identifier based on a client device key and derive the session key based on the intraoral scanning device identifier.

The processing unit may be configured to process the received 2D image data and/or 3D image data for the purpose of visualizing the data on a display, for designing dental accessories, such as aligners, retainers, crowns, implants, bracers, nightguards etc, and/or for providing diagnostic data.

The 2D image data and/or the 3D image data may be image data configured to be visualizable on a display in a 2D or a 3D manner, respectively.

The term “client device” as used herein refers to a device that communicates with the intraoral scanning device. The client device may refer to a computing device acting as a client. The client device may comprise a customization device, a handheld device, a relay, a tablet, a personal computer, a mobile phone, and/or USB dongle plugged into a personal computer. The client device may control operation of the intraoral scanning device, either by sending customization data, intraoral scanning device operating parameters, and/or firmware data. The disclosed client device and method support the intraoral scanning device in combatting attacks such as unauthorized access or control of an intraoral scanning device, while still allowing access to legitimate parties such as the client device, for e.g. customization purposes, update purposes, maintenance purposes.

The intraoral scanning device may be operated in one or more modes. The one or more modes may include a first mode and/or a second mode. The one or more modes may include a third mode and/or a fourth mode. The one or more modes may include a default mode.

The client device may comprise a memory unit and a wireless interface respectively connected to the processing unit. The wireless interface may comprise a wireless transceiver, e.g. configured for wireless communication at frequencies in the range from 2.4 to 2.5 GHz, 2.4 GHz to 5 GHz, about 2.45 GHz or about 5 GHz. The wireless transceiver may be a Bluetooth transceiver, a Bluetooth Low Energy transceiver, or a Wireless Fidelity (WIFI) transceiver. The wireless interface may form a connection to one or more other devices such as a computer, and/or a scan computer, and/or a tablet and/or a smart phone.

In an embodiment, the wireless interface is configured for communication, such as wireless communication, with an intraoral scanning device comprising a wireless transceiver.

The processing unit may be configured to send a session request for a session to the intraoral scanning device via the wireless interface. The processing unit may be configured to receive a session response from the intraoral scanning device via the wireless interface, e.g. from an intraoral scanning device and/or a session key apparatus. The session response may comprise the intraoral scanning device identifier or an identifier derived therefrom. In an exemplary client device, the client device may receive the intraoral scanning device identifier during a pairing of the client device and the intraoral scanning device. Hence, the processing unit comprises e.g. a receive/send unit configured to send data such as the session request and/or receive data such as the session response via the wireless interface. The processing unit may be configured to obtain a session key based on e.g. the session response, such as to extract the session key from or based on the session response. Hence, the processing unit comprises an obtainer. The processing unit may retrieve the session key from a key depository, e.g. stored in the memory unit. The processing unit may be configured to obtain a session key, wherein to obtain a session key may comprise to establish a connection to a session key apparatus via the wireless interface. The processing unit may send a session key request to the session key apparatus such as a session key server via the wireless interface e.g. via a wireless communication link established between the client device and the session key apparatus via the wireless interface. The processing unit may receive a session key response from the session key apparatus via the wireless interface, and may determine the session key based on the session key response.

The session response may comprise an intraoral scanning device identifier. The intraoral scanning device identifier may comprise a hardware number of the intraoral scanning device and/or a serial number of the intraoral scanning device. The client device may retrieve the session key from the session key apparatus by providing the intraoral scanning device identifier to the session key apparatus, e.g. as part of the session key request, and requesting the session key or an intraoral scanning device key from the session key apparatus and/or requesting the session key apparatus to decrypt the session response and/or the session key.

In one or more exemplary client devices, the processing unit configured to obtain the session key may be configured to establish a connection to a session key apparatus via the wireless interface, to send a session key request to the session key apparatus via the wireless interface, to receive a session key response from the session key apparatus via the wireless interface, and to determine the session key based on the session key response. The session key request may comprise the intraoral scanning device identifier. The connection to the session key apparatus may be a secure connection over a network, such as including a private and/or a public network.

The session key apparatus may be a customization accessory device; wherein the customization accessory device optionally comprises a storage device containing a list configured to provide a session key and/or a session key response based on a session key request.

The processing unit may be configured to determine intraoral scanning device data. Hence the processing comprises e.g. a determiner. The intraoral scanning device data comprises e.g. firmware, customization data, and/or intraoral scanning device operating parameters.

Customization data may for example be setting data of the intraoral scanning device, such as power management settings, configuration settings, configuration of a user interface of the intraoral scanning device and/or settings of an optical unit of the intraoral scanning device. Firmware may refer to a computer program provided by the intraoral scanning device manufacturer, and to be installed on the intraoral scanning device to control the intraoral scanning device. Firmware is for example to be installed to upgrade the operations and capabilities of the intraoral scanning device.

The optical unit may include one or more light projectors, one or more optical components, and one or more image sensors.

The user interface of the intraoral scanning device may include at least a touch sensor, at least a touch button, at least a light emitting diode, a haptic sensor, and/or an accelerometer.

The session response may comprise an encrypted session key. The processing unit may be configured to determine the session key by retrieving the session key from the session key response.

In one or more exemplary client device, to determine the session key comprises retrieving an intraoral scanning device key from the session key response or from the memory unit and decrypting the encrypted session key based on the intraoral scanning device key. To determine the session key may comprise decrypting the encrypted session key with a global key. A global is e.g. a key common to a group of client devices. The processing unit may be configured to retrieve an intraoral scanning device key from the session key response and decrypt the encrypted session key based on the intraoral scanning device key. The processing unit may comprise a decrypt/encrypt unit. The intraoral scanning device key may be e.g. a symmetric key or a public key of a private-public key pair. The intraoral scanning device key may comprise an AES-128 bits key as a symmetric key. The use of a symmetric key as an intraoral scanning device key provides the advantage of being able to use hardware accelerators. The intraoral scanning device key may comprise a public key of a private-public key pair, such as a public key of a private-public key pair of an authorized discloser of the session key, such as of the client device or the session key apparatus.

The processing unit may be configured to determine the session key by including a decryption of the encrypted session key with a global key, i.e. to determine the session key may comprise decrypting the encrypted session key with a global key. The global key may be e.g. a symmetric key or a public key of a private-public key pair. The session key may be compliant with an encryption standard such as Advanced Encryption Standard, AES, RSA crypto-system, Triple Data Encryption Algorithm.

The processing unit may be configured to generate session data, e.g. including a message authentication code, based on the session key and the intraoral scanning device data. Hence the processing unit may comprise a generator. The processing unit may generate a message authentication code based on the session key and the intraoral scanning device data. The message authentication code may be included in the session data. The processing unit may be configured to generate session data based on an intraoral scanning device key. The processing unit may be configured to digitally sign the intraoral scanning device data, such as to digitally sign the intraoral scanning device data using a private key of the client device, and/or of a group of client devices. The processing unit may be configured to digitally sign the intraoral scanning device data using a private key obtained from the session key apparatus, e.g. as part of a session key response. The processing unit may generate a digital signature using a signature generation function and a private key of a client device and append the digital signature to the session data. The intraoral scanning device may then verify the digital signature when receiving the session data. If the digital signature is not successfully verified using the alleged public key of a client device, the intraoral scanning device may disregard the session data and/or terminate the session. This may provide the advantage that the client device supports the intraoral scanning device in rejecting session data tampered or received from unauthenticated parties and the communication with the intraoral scanning device may thus be robust against impersonation and masquerading attacks.

The processing unit may be configured to send the session data to the intraoral scanning device via the wireless interface, e.g. using the receive/send unit. The session data may comprise intraoral scanning device data encrypted with the session key. To encrypt session data with the session key, the client device may utilize any of the above encryption standards.

### BRIEF DESCRIPTION OF THE FIGURES

Aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 illustrates an exemplary architecture according to this disclosure;

FIG. 2 illustrates an exemplary intraoral scanning device;

FIG. 3 shows an exemplary sequence diagram between an intraoral scanning device and a client device.

FIG. 4 shows an exemplary sequence diagram;

FIG. 5 illustrates an exemplary flowchart of a method;

FIG. 6 illustrates an exemplary architecture according to this disclosure;

FIG. 7A illustrates an exemplary intraoral scanning device;

FIG. 7B illustrates an exemplary client device;

FIG. 8 shows an exemplary sequence diagram; and

FIG. 9 illustrates an exemplary flowchart of a method.

### DETAILED DESCRIPTION

The detailed description set forth below in connection with the appended drawings is intended as a description of various configurations. The detailed description includes specific details for the purpose of providing a thorough understanding of various concepts.

However, it will be apparent to those skilled in the art that these concepts may be practiced without these specific details. Several aspects of the devices, systems, mediums, programs and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A scanning for providing intraoral scan data may be performed by a dental scanning system that may include an intraoral scanning device such as the TRIOS series scanners from 3Shape A/S. The dental scanning system may include a wireless capability as provided by a wireless network unit. The intraoral scanning device may employ a scanning principle such as triangulation-based scanning, confocal scanning, focus scanning, ultrasound scanning, x-ray scanning, stereo vision, structure from motion, optical coherent tomography OCT, or any other scanning principle. In an embodiment, the intraoral scanning device is operated by projecting a pattern and translating a focus plane along an optical axis of the intraoral scanning device and capturing a plurality of 2D images at different focus plane positions such that each series of captured 2D images corresponding to each focus plane forms a stack of 2D images. The acquired 2D images are also referred to herein as raw 2D images, wherein raw in this context means that the images have not been subject to image processing. The focus plane position is preferably shifted along the optical axis of the scanning system, such that 2D images captured at a number of focus plane positions along the optical axis form said stack of 2D images (also referred to herein as a sub-scan) for a given view of the object, i.e. for a given arrangement of the scanning system relative to the object. After moving the intraoral scanning device relative to the object or imaging the object at a different view, a new stack of 2D images for that view may be captured. The focus plane position may be varied by means of at least one focus element, e.g., a moving focus lens. The intraoral scanning device is generally moved and angled during a scanning session, such that at least some sets of sub-scans overlap at least partially, in order to enable stitching in the post-processing. The result of stitching is the digital 3D representation of a surface larger than that which can be captured by a single sub-scan, i.e. which is larger than the field of view of the 3D scanning device. Stitching, also known as registration, works by identifying overlapping regions of 3D surface in various sub-scans and transforming sub-scans to a common coordinate system such that the overlapping regions match, finally yielding the digital 3D model. An Iterative Closest Point (ICP) algorithm may be used for this purpose. Another example of an intraoral scanning device is a triangulation scanner, where a time varying pattern is projected onto the dental object and a sequence of images of the different pattern configurations are acquired by one or more cameras located at an angle relative to the projector unit.

The intraoral scanning device comprises one or more light projectors configured to generate an illumination pattern to be projected on a three-dimensional dental object during a scanning session. The light projector(s) preferably comprises a light source, a mask having a spatial pattern, and one or more lenses such as collimation lenses or projection lenses. The light source may be configured to generate light of a single wavelength or a combination of wavelengths (mono- or polychromatic). The combination of wavelengths may be produced by using a light source configured to produce light (such as white light) comprising different wavelengths. Alternatively, the light projector(s) may comprise multiple light sources such as LEDs individually producing light of different wavelengths (such as red, green, and blue) that may be combined to form light comprising the different wavelengths. Thus, the light produced by the light source may be defined by a wavelength defining a specific color, or a range of different wavelengths defining a combination of colors such as white light. In an embodiment, the intraoral scanning device comprises a light source configured for exciting fluorescent material of the teeth to obtain fluorescence data from the dental object. Such a light source may be configured to produce a narrow range of wavelengths. In another embodiment, the light from the light source is infrared (IR) light, which is capable of penetrating dental tissue. The light projector(s) may be DLP projectors using a micro mirror array for generating a time varying pattern, or a diffractive optical element (DOF), or back-lit mask projectors, wherein the light source is placed behind a mask having a spatial pattern, whereby the light projected on the surface of the dental object is patterned. The back-lit mask projector may comprise a collimation lens for collimating the light from the light source, said collimation lens being placed between the light source and the mask. The mask may have a checkerboard pattern, such that the generated illumination pattern is a checkerboard pattern. Alternatively, the mask may feature other patterns such as lines or dots, etc.

The intraoral scanning device preferably further comprises optical components for directing the light from the light source to the surface of the dental object. The specific arrangement of the optical components depends on whether the intraoral scanning device is a focus scanning apparatus, a scanning device using triangulation, or any other type of intraoral scanning device. A focus scanning apparatus is further described in EP 2 442 720 B1 by the same applicant, which is incorporated herein in its entirety.

The light reflected from the dental object in response to the illumination of the dental object is directed, using optical components of the intraoral scanning device, towards the image sensor(s). The image sensor(s) are configured to generate a plurality of images based on the incoming light received from the illuminated dental object. The image sensor may be a high-speed image sensor such as an image sensor configured for acquiring images with exposures of less than 1/1000 second or frame rates in excess of 250 frames pr. second (fps). As an example, the image sensor may be a rolling shutter (CCD) or global shutter sensor (CMOS). The image sensor(s) may be a monochrome sensor including a color filter array such as a Bayer filter and/or additional filters that may be configured to substantially remove one or more color components from the reflected light and retain only the other non-removed components prior to conversion of the reflected light into an electrical signal. For example, such additional filters may be used to remove a certain part of a white light spectrum, such as a blue component, and retain only red and green components from a signal generated in response to exciting fluorescent material of the teeth.

The network unit may be configured to connect the dental scanning system to a network comprising a plurality of network elements including at least one network element configured to receive the processed data. The network unit may include a wireless network unit. The wireless network unit is configured to wirelessly connect the dental scanning system to the network comprising the plurality of network elements including the at least one network element configured to receive the processed data.

The dental scanning system preferably further comprises a processor configured to generate scan data (such as intraoral scan data) by processing the two-dimensional (2D) images acquired by the intraoral scanning device. The processor may be part of the intraoral scanning device. As an example, the processor may comprise a Field-programmable gate array (FPGA) and/or an Advanced RISC Machines (ARM) processor located on the intraoral scanning device. The scan data comprises information relating to the three-dimensional dental object. The scan data may comprise any of: 2D images, 3D point clouds, depth data, texture data, intensity data, color data, and/or combinations thereof. As an example, the scan data may comprise one or more point clouds, wherein each point cloud comprises a set of 3D points describing the three-dimensional dental object. As another example, the scan data may comprise images, each image comprising image data e.g. described by image coordinates and a timestamp (x, y, t), wherein depth information can be inferred from the timestamp. The image sensor(s) of the intraoral scanning device may acquire a plurality of raw 2D images of the dental object in response to illuminating said object using the one or more light projectors. The plurality of raw 2D images may also be referred to herein as a stack of 2D images. The 2D images may subsequently be provided as input to the processor, which processes the 2D images to generate scan data. The processing of the 2D images may comprise the step of determining which part of each of the 2D images are in focus in order to deduce/generate depth information from the images. The depth information may be used to generate 3D point clouds comprising a set of 3D points in space, e.g., described by cartesian coordinates (x, y, z). The 3D point clouds may be generated by the processor or by another processing unit. Each 2D/3D point may furthermore comprise a timestamp that indicates when the 2D/3D point was recorded, i.e., from which image in the stack of 2D images the point originates. The timestamp is correlated with the z-coordinate of the 3D points, i.e., the z-coordinate may be inferred from the timestamp. Accordingly, the output of the processor is the scan data, and the scan data may comprise image data and/or depth data, e.g. described by image coordinates and a timestamp (x, y, t) or alternatively described as (x, y, z). The intraoral scanning device may be configured to transmit other types of data in addition to the scan data. Examples of data include 3D information, texture information such as infra-red (IR) images, fluorescence images, reflectance color images, x-ray images, and/or combinations thereof.

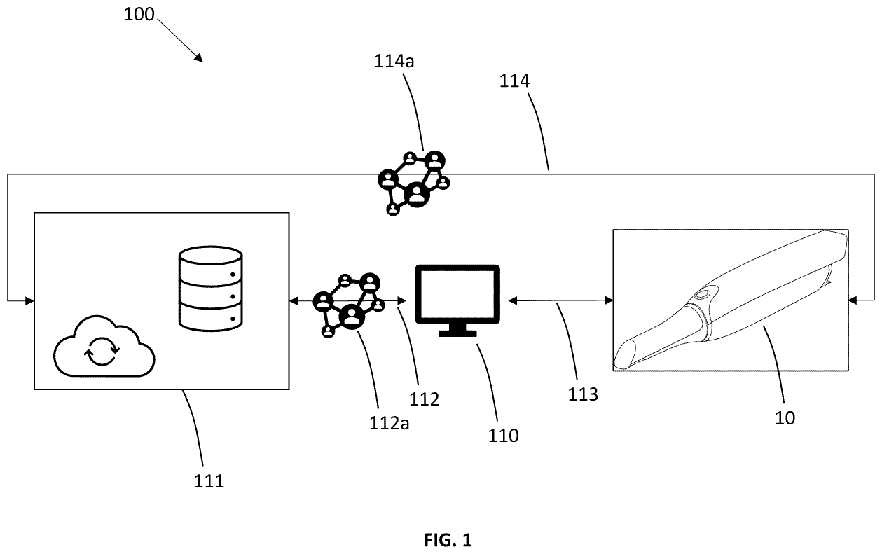

FIG. 1 schematically illustrates an exemplary architecture 100 according to this disclosure. The architecture 100 comprises an intraoral scanning device 10, a client device 110, and a server device 111. The client device 110 may comprise a computing device acting as a client, such as a customization device, a handheld device, a relay, a tablet, a personal computer, a mobile phone, and/or USB dongle plugged in a personal computer. The server device 111 may comprise a computing device configured to act as a server, i.e. to serve requests from the client device 110 and/or from the intraoral scanning device 10. The server device 111 may be controlled by the intraoral scanning device manufacturer.

The intraoral scanning device 10 may be connected to the client device 110 via a communication link 113, such as a bidirectional communication link and/or a wireless communication link. The wireless communication link may be carried over a short-range communication system, such as Bluetooth, Bluetooth low energy, and/or WIFI. The intraoral scanning device 10 may be connected to the client device 110 over a network.

The intraoral scanning device 10 may be connected to the server device 111 via a wireless communication link 114 or a bidirectional wireless communication link 114 over a network 114a, such as a bidirectional wireless communication link and/or wireless communication link over a network.

The client device 110 may be connected to the server device 111 via a communication link 112 over a network 112a, such as a bidirectional wireless communication link and/or wireless communication link over a network. In an embodiment, the network 112a may be the Internet.

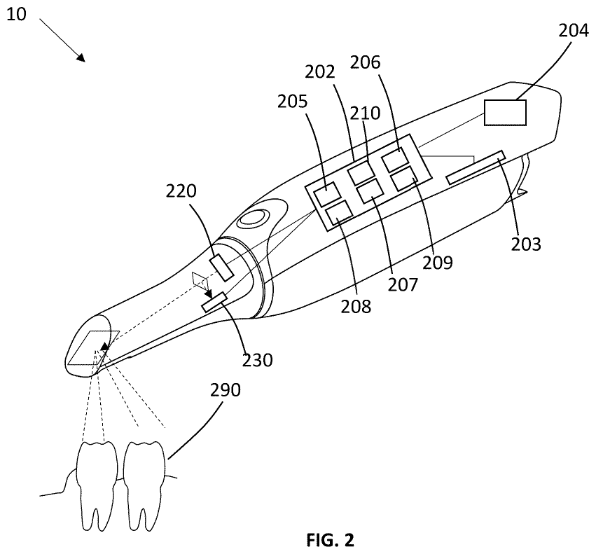

FIG. 2 schematically illustrates an exemplary intraoral scanning device 10. The exemplary intraoral scanning device 10 comprises a processing unit 202 configured to configured to process intraoral scan data of a patient and provide 2D image data and/or 3D image data.

The exemplary intraoral scanning device 10 comprises a memory unit 203 and a wireless interface 204 respectively connected to the processing unit 202. The memory is in FIG. 2 illustrated in the form of a memory unit 203 external to the processing unit 202. The memory may in other exemplary intraoral scanning devices be at least partly embedded in the processing unit 202 and/or in the memory unit 203. The processing unit 202 is configured to receive a session request for a session via the wireless interface 204. Hence, the processing unit 202 comprises a receive/send unit 205 configured to send and/or receive via the wireless interface 204. The receive/send unit 205 is configured to send and receive via the wireless interface 204 to/from an external device, such as a server device, a client device, a customization device, an accessory, a relay device, a tablet. The processing unit 202 is configured to obtain and store a session key. Hence, the processing unit 202 may comprise an obtainer 206 configured to obtain and/or generate the session key and to store the session key in e.g. the memory unit 203. To obtain the session key may comprise to generate a random or pseudo-random number with the number generator 210 contained in the intraoral scanning device 101. The processing unit 202 may comprise a random number generator 210. The session key obtained may be a 128-bits random or pseudo-random number, a 192-bits random or pseudo-random number, a 256-bits random or pseudo-random number, or any other bit-size random or pseudo-random number. The session key may be obtained so as to be compliant with an encryption standard such as Advanced Encryption Standard, AES, RSA crypto-system, Triple Data Encryption Algorithm, TDEA, Elliptic Curve Cryptographic system, any other encryption system. The session key may be uniquely generated for each session, using e.g. the number generator 210. This provides robustness against e.g. replay attacks.

The processing unit 202 is configured to sign the session key by an intraoral scanning device key, when the intraoral scanning device key may be stored in the permanent memory of the intraoral scanning device. The processing unit 202 is configured to send a session response comprising the signed session key, for example by using the receive/send unit 205 and the wireless interface 204. The processing unit 202 is configured to receive session data in the session via the wireless interface 204, for example by using the receive/send unit 205 and the wireless interface 204. The processing unit 202 receives the session data in the session from an external device, such as a client device 110 and/or a server device 111.

The processing unit 202 is configured to encrypt the session key based on an intraoral scanning device key. Hence, the processing unit 202 may comprise an encrypt/decrypt unit 207. The processing unit 202 is configured to send a session response comprising the encrypted session key which may be signed by the intraoral scanning device key, for example by using the receive/send unit 205 and the wireless interface 204. The processing unit 202 is configured to receive session data in the session via the wireless interface 204, for example by using the receive/send unit 205 and the wireless interface 204. The processing unit 202 receives the session data in the session from an external device, such as a client device 110 and/or a server device 111.

The intraoral scanning device comprises a light projector 220 and an image sensor 230. The light projector includes at least one or more light emitting diodes and/or one or more infrared light source for emitting light pattern to a three-dimensional dental object 290 of a patient or of a wax model 290 which is a replicate of the patient's dental. The image sensor 230 receives the reflective light from the dental object 290, and the image sensor 230 converts the reflected light into intraoral scan data. The processing unit 202 is then configured to process the intraoral scan data to 2D image data and/or 3D image data. The image data is then forwarded to the wireless interface 204 which transmits the data to an external device.

In one or more exemplary intraoral scanning devices, the processing unit 202 is configured to verify integrity of the session data. Thus, the processing unit 202 may comprise a verifier 208. For example, the processing unit 202 is configured to determine whether the integrity of the session data is corrupted, i.e. whether the session data has been tampered with or modified by an unauthorized party. The processing unit 202 detects e.g. an insertion, a deletion, and/or a substitution of data by an unauthorized party, such as by any party other than the sender.

In one or more exemplary intraoral scanning devices, the processing unit 202 is configured to terminate the session if integrity of the session data is corrupted. Thus, the processing unit 202 may comprise a terminator 209. For example, when it is determined by the processing unit 202 or the verifier 208 that the session data has been tampered with or modified (by e.g. insertion, deletion and/or substitution) by an unauthorized party, The processing unit 202 reject the received session data, and the terminator 209 or the processing unit 202 terminates the session with e.g. an external device. Terminating the session comprises deleting the session key from e.g. the memory unit 203. Deleting the session key protects the intraoral scanner device 10 against any replay attack or any attack based on any communication captured by an attacker.

In one or more exemplary intraoral scanning devices, the session data comprises a message authentication code, and the processing unit 202 verifying integrity of the session data is configured to verify the message authentication code with the stored session key. Thus, the verifier 208 is configured to verify the message authentication code with the stored session key. A message authentication code, MAC, is generated by a sender, such as an external device, based on the session data and the decrypted session key. Upon reception of the session data comprising the MAC, the intraoral scanning device which holds the stored session key is able to re-compute the MAC based on the received session data and a MAC generation function and compare the recomputed MAC with the received MAC. If the recomputed MAC does not match the received MAC, then the intraoral scanning device concludes that session data is corrupted. The intraoral scanning device disregards the session data and terminates the session. For example, the processing unit 202 disregards the session data and terminates the session using the terminator 208.

In one or more exemplary intraoral scanning devices, the session data comprises a digital signature. The processing unit 202 verifying integrity of the session data is configured to verify the digital signature. For example, the verifier 208 is configured to verify the digital signature. The processing unit 202 verifies the digital signature using a signature verification function and a public key of a sender that has generated the digital signature and appended it to the session data. If the processing unit 202 determines that the digital signature is not successfully verified using the alleged public key of a sender, the processing unit 202 disregards the session data and terminates the session. This may provide the advantage that the intraoral scanning device 10 rejects session data tampered or received from unauthenticated parties and is thus robust against impersonation and masquerading attacks.

In one or more exemplary intraoral scanning devices, the processing unit 202 is configured to decrypt the session data with the session key, and to store at least part of decrypted session data in the memory unit 203. A client device 110 or a server device 111 may send encrypted session data to the intraoral scanning device 10. The processing unit 202 receives the encrypted session data via the receive/send unit 205 and the wireless interface 204. The processing unit 202 retrieves the session key from e.g. the memory unit 203, and decrypts the session data using the retrieved session key and a decryption function. The processing unit 202 stores the decrypted session data in the memory unit 203. The processing unit 202 is configured to terminate the session if decryption of the session data fails. The decryption of the session data may fail if the session data is encrypted with a key different from the session key stored at the intraoral scanning device 10. This may provide the advantage that the intraoral scanning device 10 rejects session data received from parties not holding the session key and is thus robust against attacks based on such illegitimate data.

In one or more exemplary intraoral scanning devices, the session data comprises customization data, intraoral scanning device operating parameters, and/or firmware data. Firmware may refer to a computer program provided by the intraoral scanning device manufacturer, and to be installed on the intraoral scanning device to control the intraoral scanning device. Firmware is for example to be installed to upgrade the operations and capabilities of the intraoral scanning device. The customization data may include, for example, settings of a color image sensor of an intraoral scanning device. An intraoral scanning device may include a color image sensor, such as an RGB image sensor where the customization data may include information about different color areas to be deactivated and/or activated during at least a scanning session. Thus, the customization data may relate to which color areas of the RBG image sensor should be activated or deactivated during a scanning session. An intraoral scanning device may include a monochromatic image sensor and colored light emitting diodes, and in this example, the customization data may include information about which of the different colored light emitting diodes should be deactivated and/or activated during a scanning session. Thus, the customization data may include information that relates to which colored light emitting diodes should be activated or deactivated during a scanning session. A colored light emitting diode may be configured to emit light with a color, such as blue, red, green etc. In another example, the intraoral scanning device could include one or more near-infrared light emitting diodes which also can be set to be activated and/or deactivated during a scanning session by the customization data. The customization data may include setting data, such as power management settings, configuration of a user interface of the intraoral scanning device and/or settings of an optical unit of the intraoral scanning device

The optical unit may include one or more light projectors, one or more optical components, and one or more image sensors.

In one or more exemplary intraoral scanning devices, the processing unit 202 is configured to process intraoral scan data of a patient and provide 2D image data and/or 3D image data according to the received session data. The processing unit 202 may perform the process intraoral scan data of a patient and provide 2D image data and/or 3D image data based on the customization data.

In one or more exemplary intraoral scanning devices, the session key comprises a symmetric key. The symmetric key may be uniquely generated for each session, using e.g. the number generator 210. The symmetric key may comprise an AES-128 bits key. The use of a symmetric key as a session key may reduce a processing power requirement, and allow the intraoral scanning device 10 to decrypt the session data with light encryption algorithms.

In one or more exemplary intraoral scanning devices, the intraoral scanning device key is a symmetric key or a public key of a private-public key pair. The intraoral scanning device key may comprise an AES-128 bits key as a symmetric key. The use of a symmetric as an intraoral scanning device key provides the advantage of being able to use hardware accelerators. The intraoral scanning device key may comprise a public key of a private-public key pair, such as a public key of a private-public key pair of an authorized discloser of the session key, such as of a server 111.

In one or more exemplary intraoral scanning devices, the processing unit 202 is configured to send an intraoral scanning device identifier in the session response. The intraoral scanning device identifier may refer to a unique device identifier. The intraoral scanning device identifier may comprise a hardware number, a serial number, a MAC address. The session response may comprise the encrypted session key and the intraoral scanning device identifier. The processing unit 202 is configured to send an intraoral scanning device identifier in the session response to an external device such as the client device 110 or to the server device 111. The intraoral scanning device key may be stored in a permanent memory, such as memory unit 203 of the intraoral scanning device 10 during production of the intraoral scanning device 10.

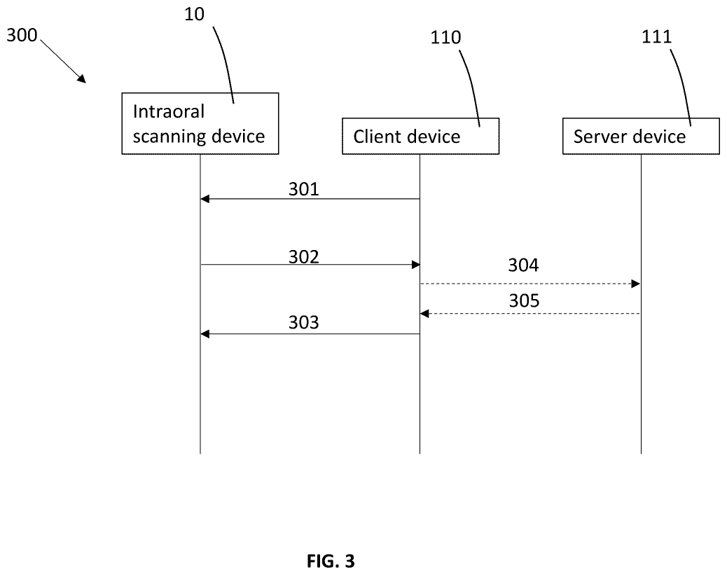

FIG. 3 shows an exemplary sequence diagram 300 between an intraoral scanning device 10, and a client device 110. The intraoral scanning device 10 receives a session request 301 for a session via the wireless interface 204 from the client device 110. The intraoral scanning device 10 obtains and stores a session key. The intraoral scanning device 10 encrypts the session key based on an intraoral scanning device key. The intraoral scanning device 10 sends to the client device 110 a session response 302 comprising the encrypted session key. The intraoral scanning device 10 may alternatively send to the client device 110 a session response 302 encrypted with the intraoral scanning device key, the session response 302 comprising the session key. The client device 110 receiving the session response 302 may request 304 the server device 111 to decrypt the encrypted session key comprised in the session response 302, or to decrypt the encrypted session response 302. Based on the request 304, the server device 111 may send the decrypted session key in a response 305 to the client device 110. This may be when the intraoral scanning device key used at the intraoral scanning device 10 is a public key of a private-public key pair of the server 101. When the intraoral scanning device key is a symmetric key, the server device 111 may send the decrypted session key in a response 305 to the client device 110 or send the intraoral scanning device key in the response 305 to the client device 110 which is then capable of decrypting the session key or the session response 302. The response 305 may comprise the decrypted session key or the intraoral scanning device key. The communication link 112 between the client device 110 and the server device 111 is secure, i.e. authenticated, encrypted and/or integrity protected using a security protocol (e.g. Transport Layer Security protocol). The intraoral scanning device 10 receives from the client device 110 session data 303 in the session via the wireless interface 204. The session data 303 may then be encrypted and/or integrity-protected at the client device 110, e.g. by use of the session key. In one or more exemplary intraoral scanning devices, the processing unit 202 is configured to verify integrity of the session data as described earlier in connection with FIG. 2. The session data 303 may comprise a message authentication code. A message authentication code, MAC, is generated by a sender, such as a client device/server device, based on the session data and the decrypted session key. Upon reception of the session data comprising the MAC, the intraoral scanning device which holds the stored session key is able to re-compute the MAC based on the received session data and a MAC generation function and compare the recomputed MAC with the received MAC. If the recomputed MAC does not match the received MAC, then the intraoral scanning device concludes that session data is corrupted. The intraoral scanning device disregards the session data and terminates the session. For example the processing unit 202 disregards the session data and terminates the session using the terminator 208.

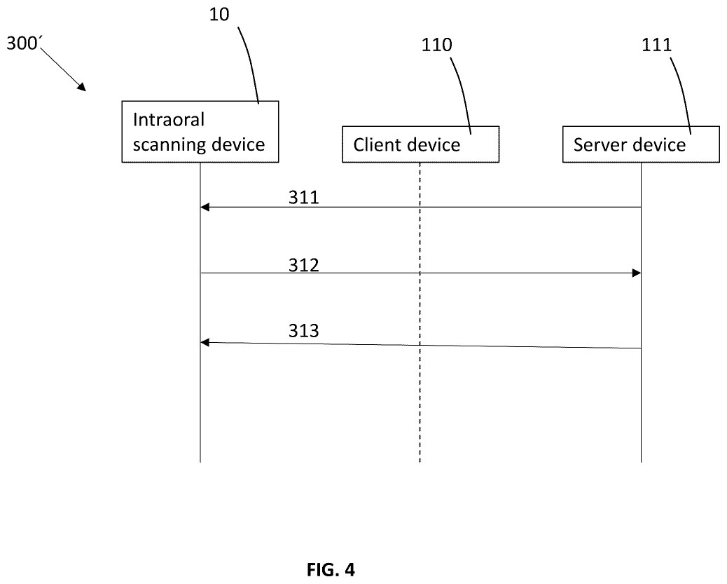

FIG. 4 shows an exemplary sequence diagram 300′ between an intraoral scanning device 10, a client device 110, and a server device 111. The intraoral scanning device 10 receives a session request 311 for a session via the wireless interface 204 from the server device 111. The intraoral scanning device 10 obtains and stores a session key. The intraoral scanning device 10 encrypts the session key based on an intraoral scanning device key. The intraoral scanning device 10 sends to the server device 111 a session response 312 comprising the encrypted session key. The intraoral scanning device 10 may alternatively send to the server device 111 a session response 312 encrypted with the intraoral scanning device key, the session response 312 comprising the session key. The server device 111 may decrypt the encrypted session key comprised in the session response 312, or the encrypted session response 312. The communication link 112 between the intraoral scanning device 10 and the server device 111 may be over the client device 110 and/or over a network. The communication link 112 between the intraoral scanning device 10 and the server device 111 may or may not be secure, i.e. authenticated, encrypted and/or integrity protected using a security protocol. The intraoral scanning device 10 receives from the server device 111 session data 313 in the session via the wireless interface 204. The session data 313 may then be encrypted and/or integrity-protected at the server device 111.

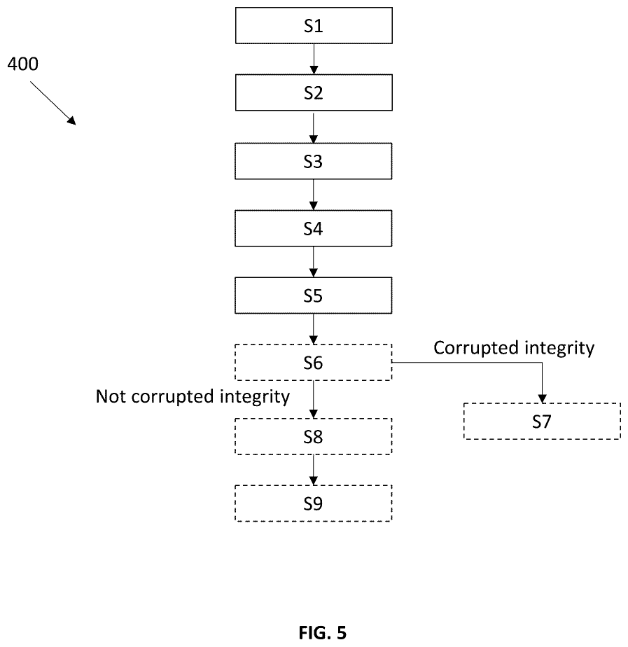

FIG. 5 schematically illustrates a flowchart 400 of an exemplary method according to this disclosure. The method 400 is proposed for communication of an intraoral scanning device 10 comprising a processing unit 202, a memory unit 203, and a wireless interface 204, such as for protecting communication of an intraoral scanning device with e.g. an external device (client device and/or server device and/or accessory equipment). The method 400 is performed in the intraoral scanning device 10. The method 400 comprises receiving S1 a session request for a session via the wireless interface 204. Receiving S1 may comprise receiving a session request from an external device, such as the client device 110 and/or the server device 111.

The method 400 comprises obtaining and storing S2 a session key, such as in a memory unit 203. Obtaining and storing S2 a session key, such as in a memory unit 203 may comprise generating a random or pseudo-random number with the number generator 210 contained in the intraoral scanning device 10. Obtaining and storing S2 a session key may comprise generating a 128-bits random or pseudo-random number, a 192-bits random or pseudo-random number, a 256-bits random or pseudo-random number, or any other bit-size random or pseudo-random number.

The method 400 comprises encrypting S3 the session key based on an intraoral scanning device key. Encrypting and/or signing S3 the session key based on an intraoral scanning device key. The encrypting may comprise using an encryption standard such as Advanced Encryption Standard, AES, RSA crypto-system, Triple Data Encryption Algorithm, TDEA, Elliptic Curve Cryptographic system, any other encryption system.

The method 400 comprises sending S4 a session response comprising the encrypted and/or signed session key, and receiving S5 session data in the session via the wireless interface. Sending S4 a session response comprising the encrypted and/or signed session key may comprise sending the session response to a client device 110 and/or a server device 111. Receiving S5 session data in the session via the wireless interface 204 may comprise receiving session data from a client device 110 and/or a server device 111.

In one or more exemplary methods, the method 400 comprises verifying S6 integrity of the session data. Verifying S6 integrity of the session data may comprise determining whether the integrity of the session data is corrupted, i.e. determining whether the session data has been tampered with or modified by an unauthorized party. Verifying S6 integrity of the session data may comprise detecting e.g. an insertion, a deletion, and/or a substitution of data by an unauthorized party, such as by any party other than the legitimate sender. Verifying S6 integrity of the session data may comprise verifying a message authentication code appended to the session data (e.g. using the stored session key) and/or a digital signature appended to the session data. When it is determined that the integrity of the session data is not corrupted, then the intraoral scanning device 10 may grant access to reading and/or writing memory areas to the external device. For example, the session data or intraoral scanning device data derived therefrom may be written in the memory unit 203.

The method 400 comprises terminating S7 the session if integrity of the session data is corrupted. For example, if it is determined that the session data has been tampered with or modified (by e.g. insertion, deletion and/or substitution) by an unauthorized party, terminating S7 comprises rejecting the received session data, and terminating the session with e.g. an external device. Terminating S7 may comprise deleting the session key from e.g. the memory unit 203.

In one or more exemplary methods, the method 400 comprises decrypting S8 the session data with the session key and storing S9 at least part of decrypted session data in the memory unit. Decrypting S8 the session data with the session key may comprise retrieving the session key from e.g. the memory unit 203, and decrypts the session data using the retrieved session key and a decryption function.

Client device for secure intraoral scanning device communication:

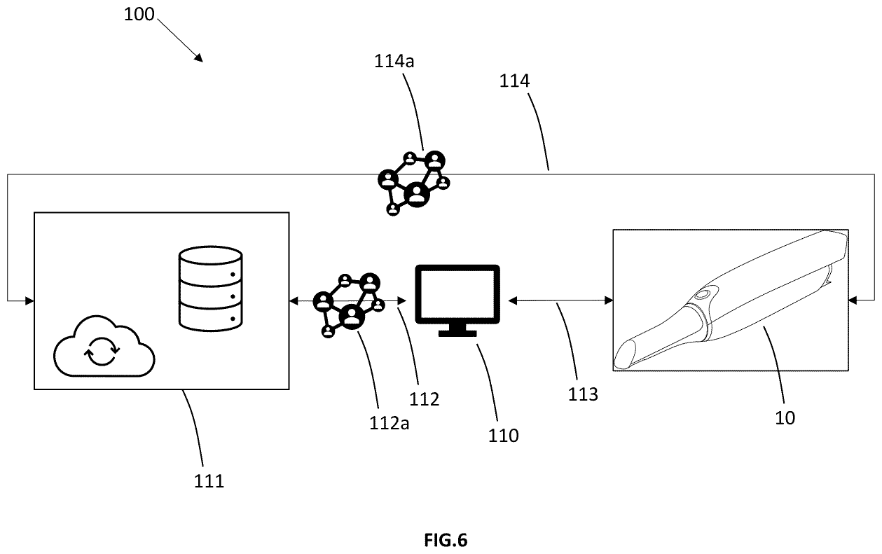

FIG. 6 illustrates an exemplary architecture 100 according to this disclosure. The architecture 100 comprises an intraoral scanning device 10, a client device 110, and a session key apparatus 111. The client device 110 may comprise a computing device acting as a client, a customization device, a handheld device, a relay, a tablet, a personal computer, a mobile phone, and/or USB dongle plugged into a personal computer. The session key apparatus 111 may comprise a computing device configured to act as a server, i.e. to serve requests from the client device 110 and/or from the intraoral scanning device 10. The server device 111 may be controlled by the intraoral scanning device manufacturer.

The intraoral scanning device 101 may be connected to the client device 110 via a communication link 113, such as a wireless communication link or a bidirectional wireless communication link. The wireless communication link may be carried over a short-range communication system, such as Bluetooth, Bluetooth low energy, IEEE 802.11, Zigbee, WIFI. The intraoral scanning device 101 may be connected to the client device 110 over a network.

The intraoral scanning device 101 may be connected to the session key apparatus 111 via a wireless communication link 114 or a bidirectional wireless communication link 114 over a network 114a, such as a bidirectional wireless communication link and/or wireless communication link over a network.

The client device 110 may be connected to the session key apparatus 111 via a communication link 112 over a network 112a, such as a bidirectional wireless communication link and/or wireless communication link over a network. In an embodiment, the network 112a may be the Internet.

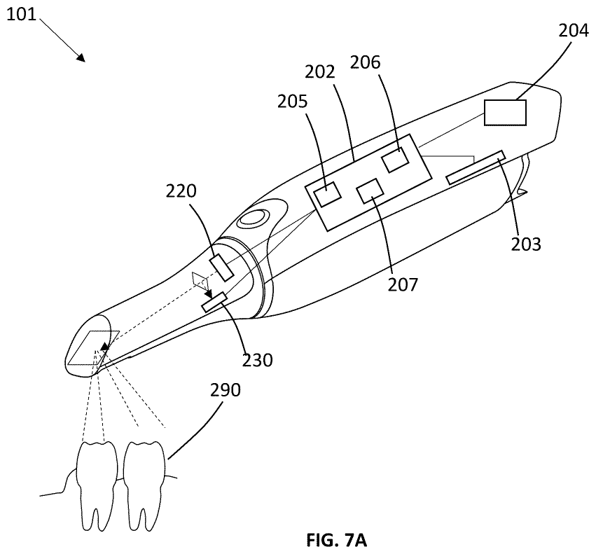

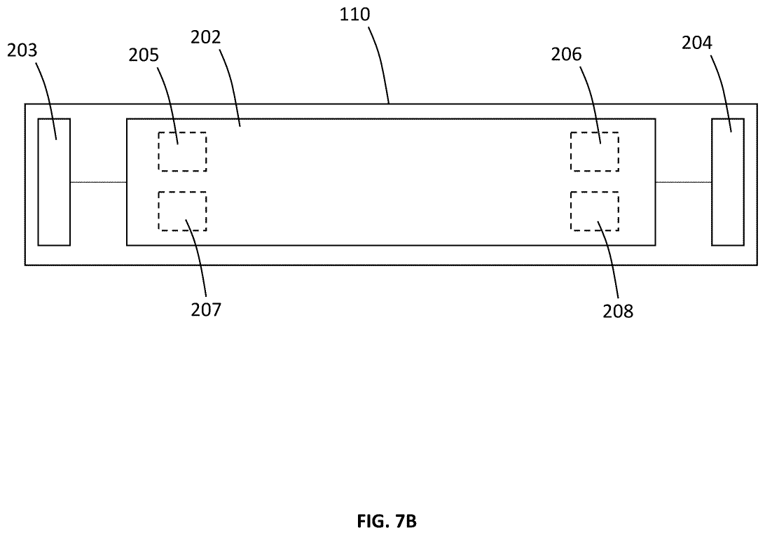

FIG. 7A illustrates an exemplary intraoral scanning device 10. The exemplary intraoral scanning device 101 comprises a processing unit 202 configured to process intraoral scan data of a patient 290 and provide 2D image data and/or 3D image data. The exemplary intraoral scanning device 101 comprises a memory and a wireless interface 204. The memory is in FIG. 7A illustrated in the form of a memory unit 203 external to the processing unit 202. The memory may in other exemplary intraoral scanning devices be at least partly embedded in the processing unit 202 and/or in the memory unit 203.

The processing unit 202 is configured to receive a mode request via the wireless interface 204. Hence, the processing unit 202 comprises a receive/send unit 205 configured to send and/or receive via the wireless interface 204. The receive/send unit 205 is configured to send and receive via the wireless interface 204 to/from an external device, such as a server device, a client device, a customization device, an accessory, a relay device, a smart phone. The processing unit 202 is configured to authenticate the mode request. Hence, the processing unit 202 may comprise an authenticator 206 configured to authenticate the mode request. The processing unit 202 is configured to place the intraoral scanning device into the requested mode, such as a service mode, a customization mode, an upgrade mode or debug mode, if authentication of the mode request succeeds. Hence the processing unit 202 comprises a mode controller 207 configured to place the intraoral scanning device 101 into the requested mode, e.g. based on an output from the authenticator 206. In the intraoral scanning device in FIG. 7A, the processing unit 202 is configured to place the intraoral scanning device into a default mode if authentication of the mode request fails, the default mode comprising booting the intraoral scanning device and operating the intraoral scanning device according to operating parameters set during booting. In an embodiment, the operating parameters set during booting may be stored in a non-volatile part of the memory unit 203. In an embodiment, the operating parameters set during booting may comprise a default setting enabling the intraoral scanning device to function according to a default setting programmed during production of the intraoral scanning device.

The intraoral scanning device comprises a light projector 220 and an image sensor 230. The light projector includes at least one or more light emitting diodes and/or one or more infrared light source for emitting light pattern to a three-dimensional dental object 290 of a patient or of a wax model 290 which is a replicate of the patient's dental. The image sensor 230 receives the reflective light from the dental object 290, and the image sensor 230 converts the reflected light into intraoral scan data. The processing unit 202 is then configured to process the intraoral scan data to 2D image data and/or 3D image data. The image data is then forwarded to the wireless interface 204 which transmits the data to an external device.

FIG. 7B schematically illustrates an exemplary client device 110. The exemplary client device 110 comprises a processing unit 202 configured communicate with an intraoral scanning device 101. The exemplary client device 110 comprises a memory unit 203 and a wireless interface 204 respectively connected to the processing unit 202. The processing unit 202 is configured to send a session request for a session to the intraoral scanning device via the wireless interface. The session request may comprise the intraoral scanning device identifier or an identifier derived therefrom. The processing unit 202 is configured to receive a session response via the wireless interface, e.g. from an intraoral scanning device 101 and/or a session key apparatus 111. Hence, the processing unit 202 comprises e.g. a receive/send unit 205 configured to send and/or receive via the wireless interface 204. The processing unit 202 is configured to obtain a session key based on e.g. the session response, such as to extract the session key from the session response. Hence, the processing unit 202 comprises an obtainer 206. The processing unit 202 may retrieve the session key from a key depository, e.g. stored in the memory unit 203.

To obtain a session key may comprise validating the intraoral scanning device identifier based on a client device key and derive the session key based on the intraoral scanning device identifier.

Alternatively, to obtain a session key may comprise to establish a connection to a session key apparatus 111 via the wireless interface 204, i.e. the processing unit 202 may be configured to establish a connection to a session key apparatus via the wireless interface. The processing unit 202 may send a session key request, e.g. comprising an intraoral scanning device identifier, to the session key apparatus via the wireless interface 204. The processing unit 202 may receive a session key response from the session key apparatus 111 via the wireless interface 204, the session key response optionally comprising an intraoral scanning device key. The processing unit 202 may determine the session key based on the session key response, e.g. by decrypting the encrypted session key with the intraoral scanning device key from the session key apparatus.

The session response may comprise an intraoral scanning device identifier. The intraoral scanning device identifier may comprise a hardware number of the intraoral scanning device and/or a serial number of the intraoral scanning device. The client device 110 may retrieve the session key from the session key apparatus 111 by providing the intraoral scanning identifier to the session key apparatus 111 and requesting the session key from the session key apparatus 111 and/or requesting the session key apparatus 111 to decrypt the session response and/or the session key.

In one or more exemplary client devices, to obtain the session may comprise to establish a connection to a session key apparatus via the wireless interface, to send a session key request to the session key apparatus via the wireless interface, to receive a session key response from the session key apparatus via the wireless interface, and to determine the session key based on the session key response. The connection establishment may be a secure connection establishment e.g. using a secure protocol to a server acting as session key apparatus.

The processing unit 202 is configured to determine intraoral scanning device data. Hence the processing comprises e.g. a determiner. The intraoral scanning device data comprises e.g. firmware, customization data, and/or intraoral scanning device operating parameters. Thus, the client device 110 may be a customization computer or a dentist computer. Customization data may for example be data generated by a customization computer used by a dentist. Customization data may comprise setting data of the intraoral scanning device, such as power management settings, configuration settings, configuration of a user interface of the intraoral scanning device and/or settings of an optical unit of the intraoral scanning device. Intraoral scanning device operation parameters may comprise mode and/or program control parameters. Firmware may refer to a computer program provided by the intraoral scanning device manufacturer, and to be installed on the intraoral scanning device to control the intraoral scanning device. Firmware is for example to be installed to upgrade the operations and capabilities of the intraoral scanning device.

The client device may be in the form of a desktop computer, a laptop, or a tablet that comprises software configured to provide the functionality of a customization computer.

The session response may comprise an encrypted session key. The processing unit 202 may be configured to determine the session key by retrieving the session key from the session key response

In one or more exemplary client devices, to determine the session key comprises retrieving an intraoral scanning device key from the session key response and decrypting the encrypted session key based on the intraoral scanning device key. Alternatively to determine the session key may comprise decrypting the encrypted session key with a global key. A global is e.g. a key common to a group of client devices. The processing unit 202 is configured to e.g. retrieve an intraoral scanning device key from the session key response and decrypt the encrypted session key based on the intraoral scanning device key. The processing unit may comprise a decrypt/encrypt unit. The intraoral scanning device key may be e.g. a symmetric key or a public key of a private-public key pair. The intraoral scanning device key may comprise an AES-128 bits key as a symmetric key. The use of a symmetric as an intraoral scanning device key provides the advantage of being able to use hardware accelerators. The intraoral scanning device key may comprise a public key of a private-public key pair, such as a public key of a private-public key pair of an authorized discloser of the session key, such as of the client device 110 or the session key apparatus 111.

In one or more exemplary client devices, to determine the session key comprises decrypting the encrypted session key with a global key. The global key may be e.g. a symmetric key or a public key of a private-public key pair. The session key may be compliant with or encrypted with an encryption standard such as Advanced Encryption Standard, AES, RSA crypto-system, Triple Data Encryption Algorithm.

The processing unit 202 is configured to generate session data e.g. based on the session key and the intraoral scanning device data. Hence the processing comprises e.g. a generator 208. The processing unit 202 may generate a message authentication code based on the session key and the intraoral scanning device data. A message authentication code, MAC, is generated by a client device 110 based on the session data and the session key. Upon reception of the session data comprising the MAC, the intraoral scanning device which holds the stored session key is able to re-compute the MAC based on the received session data and a MAC generation function and compare the recomputed MAC with the received MAC. If the recomputed MAC does not match the received MAC, then the intraoral scanning device concludes that session data is corrupted. The processing unit 202 to generate session data may be configured to encrypt the intraoral scanning device data with the session, using e.g. an encryption scheme. The encryption scheme may comprise a symmetric encryption scheme and/or an asymmetric encryption scheme. The session key may comprise a symmetric key. The symmetric key may be uniquely generated for each session by the intraoral scanning device and/or session key apparatus. The symmetric key may comprise an AES-128 bits key. The use of a symmetric key as a session key may reduce a processing power requirement and allow the intraoral scanning device 101 to decrypt the session data with light encryption algorithms.

The processing unit 202 may be configured to digitally sign the intraoral scanning device data, such as to digitally sign the intraoral scanning device data using a private key of the client device, and/or of a group of client devices. The processing unit 202 generates a digital signature using a signature generation function and a private key of a client device 110 and append it to the session data. The intraoral scanning device 101 may then verify the digital signature when receiving the session data. If the digital signature is not successfully verified using the alleged public key of a client device 110, the intraoral scanning device 101 may disregard the session data and terminates the session. This may provide the advantage that the client device 110 supports the intraoral scanning device 101 in rejecting session data tampered or received from unauthenticated parties and the communication with the intraoral scanning device may thus be robust against impersonation and masquerading attacks.

The processing unit 202 is configured to send the session data to the intraoral scanning device via the wireless interface, e.g. using the receive/send unit 205. The session data may comprise intraoral scanning device data encrypted with the session key. To encrypt session data with the session key, the client device 110 may utilize any of the above encryption standards.

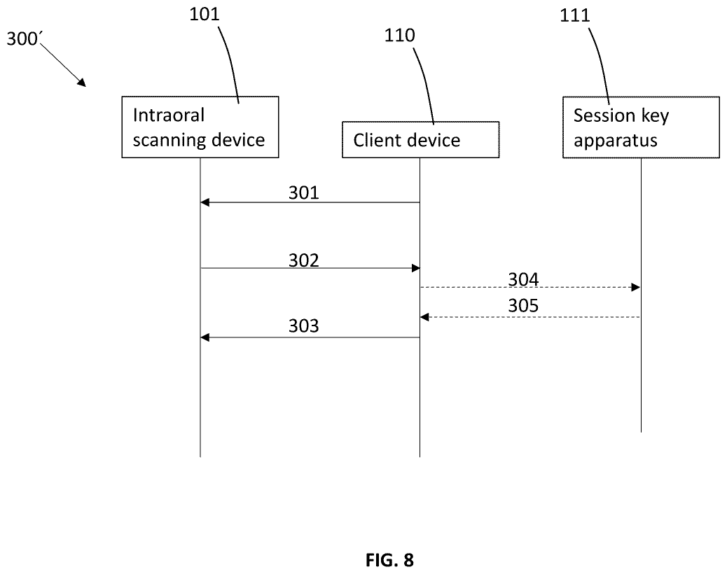

FIG. 8 shows an exemplary sequence diagram 300 involving a session key apparatus 111. A client device 110 sends to e.g. the intraoral scanning device 101 a session request 301 for a session via the wireless interface 204. The client device 110 receives from e.g. intraoral scanning device 101 a session response 302. The session response 302 may comprise an encrypted session key. The client device 110 obtains the session key. For example, to obtain the session key comprises validating the intraoral scanning device identifier based on a client device key and derive the session key based on the intraoral scanning device identifier. Alternatively, to obtain session key, the client device 110 may send a session key request 304 to the session key apparatus 111, whereupon the session key apparatus decrypts the encrypted session key comprised in the session response 302. Based on the session key request 304, the session key apparatus 111 may send the decrypted session key or an intraoral scanning device key enabling the client device to decrypt the encrypted session key in a session key response 305 to the client device 110. The session key response 305 from the session key apparatus 111 may comprise the decrypted session key. The communication link 112 between the client device 110 and the session key apparatus 111 is secure. For example, the session key apparatus 111 may be physically attached as a USB dongle to the client device 111. Alternatively, the session key apparatus 111 may be connected to the client device via a network. The communication link 112 between the client device 110 and the session key apparatus 111 may be secure, i.e. authenticated, encrypted and/or integrity protected using a security protocol (e.g. Transport Layer Security protocol). The client device 110 determines intraoral scanning device data and generates session data 303 based on the session key and the intraoral scanning device data. For example, the client device 110 encrypts the intraoral scanning device data with the session key. The session data 303 may be integrity-protected by the client device 110. The client device 110 sends the session data 303 in the session via the wireless interface 204.

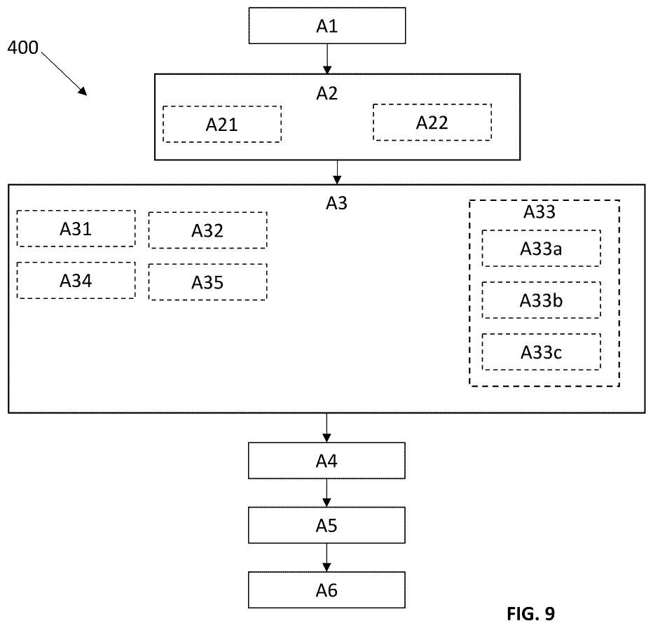

FIG. 9 shows an exemplary flowchart illustrating a method, performed in a client device 110, for intraoral scanning device communication. The client device 110 comprises a processing unit 202, a memory unit 203 and a wireless interface 204. The method comprises sending A1 a session request for a session to the intraoral scanning device 101 via the wireless interface 204, e.g. to an intraoral scanning device 101 and/or a session key apparatus 111. The method comprises receiving A2 a session response via the wireless interface 204, from an intraoral scanning device 101 and/or a session key apparatus 111.

The method comprises obtaining A3 a session key based on the session response, such as to extract the session key from the session response. Obtaining A3 a session key may comprise establishing A31 a connection to a session key apparatus 111, sending A32 a session key request to the session key apparatus 111, receiving A33 a session key response from the session key apparatus 111, and determining A34 the session key based on the session key response. The client device 110 may retrieve the session key from the session key apparatus 111 by providing the intraoral scanning device identifier to the session key apparatus 111 and requesting the session key from the session key apparatus 111 and/or requesting the session key apparatus 111 to decrypt the session response and/or the session key.

In one or more methods, receiving A2 a session response may comprise receiving A21 an encrypted session key. Determining A33 the session key may comprise retrieving A33a the session key from the session key response. Determining A33 the session key may comprises retrieving A33b an intraoral scanning device key from the session key response and decrypting A33c the encrypted session key based on the intraoral scanning device key.

In one or more methods, receiving A2 a session response may comprise receiving A21 an encrypted session key. Obtaining A3 a session key based on the session response may comprise decrypting A35 the encrypted session key with a global key. The global key may be stored in the client device 110, such as in the memory 203.

The method comprises determining A4 intraoral scanning device data. The method comprises generating A5 session data based on the session key and the intraoral scanning device data. The method comprises sending A6 the session data to the intraoral scanning device via the wireless interface.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to an component/unit/element in the singular is not intended to mean “one and only one” unless explicitly so stated, but rather “one or more.” A claim may refer to any of the preceding claims, and “any” is understood to mean “any one or more” of the preceding claims.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Item List

1. A client device (110) for intraoral scanning device communication, the client device (110) comprising
   a wireless interface (204) configured to receive 2D image data and/or 3D image data from an intraoral scanning device,
   a memory unit (203);
   a processing unit (202) configured to process the received 2D image data and/or 3D image data; and
wherein the processing unit (202) is further configured to:
   send a session request (301) for a session to the intraoral scanning device via the wireless interface (204);
   receive a session response (302) from the intraoral scanning device via the wireless interface (204), the session response (302) comprising an intraoral scanning device identifier;
   obtain a session key based on the session response (302),
   determine intraoral scanning device data;
   generate session data (303) based on the session key and the intraoral scanning device data; and
   send the session data (303) to the intraoral scanning device via the wireless interface (204).
2. Client device according to item 1, wherein to obtain a session key comprises to establish a connection to a session key apparatus (111) via the wireless interface (204), to send a session key request (304) to the session key apparatus (111) via the wireless interface (204), the session key request (304) comprising the intraoral scanning device identifier, to receive a session key response (305) from the session key apparatus (111) via the wireless interface (204), and to determine the session key based on the session key response (305).
3. Client device according to item 1, wherein to obtain a session key comprises validating the intraoral scanning device identifier based on a client device key and derive the session key based on the intraoral scanning device identifier.
4. Client device according to item 2, wherein the connection to the session key apparatus (111) is a secure connection over a network.
5. Client device according to any of items 2 to 4, wherein the session key apparatus (111) is a customization accessory device; wherein the customization accessory comprises a storage device containing a list configured to provide a session key and/or a session key response (305) based on a session key request (304).
6. Client device according to any of items 2-5, wherein the session key apparatus (111) is a computer-server; wherein the computer-server comprises a storage device containing a list configured to provide a session key and/or a session key response (305) based on a session key request (304).
7. Client device according to any of items 2-6, wherein the session response (302) comprises an encrypted session key, and wherein to determine the session key comprises retrieving the session key from the session key response (305).
8. Client device according to item 7, wherein to determine the session key comprises retrieving a intraoral scanning device key from the session key response (305) and decrypting the encrypted session key based on the intraoral scanning device key; or wherein to determine the session key comprises decrypting the encrypted session key with a global key.
9. Client device according to any of the preceding items, wherein to generate session data (303) based on the session key and the intraoral scanning device data comprises generating a message authentication code based on the session key and the intraoral scanning device data.
10. Client device according to any of the preceding items, wherein to generate session data based on the session key and the intraoral scanning device data comprises digitally signing the intraoral scanning device data.
11. Client device according to any of the preceding items wherein the intraoral scanning device data comprises firmware, customization data, and/or intraoral scanning device operating parameters.
12. A method, performed in a client device (110), for intraoral scanning device communication, the client device (110) comprising a processing unit (202), a memory unit (203) and a wireless interface (204) configured to receive 2D image data and/or 3D image date from an intraoral scanning device, the method comprising:
   sending a session request (301) for a session to the intraoral scanning device via the wireless interface (204);
   receiving a session response (302) via the wireless interface (204);
   obtaining a session key based on the session response (302),
   determining intraoral scanning device data;
   generating session data (303) based on the session key and the intraoral scanning device data; and
   sending the session data (303) to the intraoral scanning device via the wireless interface (204).
13. Method according to item 12, wherein obtaining a session key comprises establishing a connection to a session key apparatus (111), sending a session key request (304) to the session key apparatus (111), receiving a session key response (305) from the session key apparatus (111), and determining the session key based on the session key response (305);
14. Method according to any of items 12 and 13, wherein receiving a session response (302) comprises receiving an encrypted session key, and wherein determining the session key comprises retrieving the session key from the session key response (302)
15. Method according to any of items 12 to 14, wherein determining the session key comprises retrieving a intraoral scanning device key from the session key response (305) and decrypting the encrypted session key based on the intraoral scanning device key.
16. Method according to any of items 12 to 15, wherein receiving a session response (302) comprises receiving an encrypted session key, and obtaining a session key based on the session response (302) comprises decrypting the encrypted session key with a global key.

1. A handheld intraoral scanning device configured to acquire intraoral scan data from a three-dimensional dental object during a scanning session, the handheld intraoral scanning device comprising
a processing unit configured to process intraoral scan data of a patient and provide 3D image data;
a wireless interface configured to transmitting the 3D image data, and
a memory;
wherein the processing unit is configured to:
receive a session request for a session via the wireless interface, wherein the session request includes a digital signature;
authenticate the digital signature for initiating the session;
obtain and store a session key;
sign the session key by an intraoral scanning device key, wherein the intraoral scanning device key is stored in a permanent memory of the intraoral scanning device;
send a session response comprising the signed session key; and
receive session data in the session via the wireless interface (204), and wherein the session data corresponds to customization data for the handheld intraoral scanning device, handheld intraoral scanning device operating parameters and/or firmware data for the handheld intraoral scanning device.

2. A handheld intraoral scanning device according to claim 1, wherein the session key is encrypted based on the intraoral scanning device key, and where the session response includes the encrypted session key.

3. A handheld intraoral scanning device according to claim 1, wherein the processing unit is configured to receive a client signed session key via the wireless interface, and decrypt the received session data in the session.

4. A handheld intraoral scanning device according to claim 1, wherein the processing unit is configured to verify integrity of the session data.

5. A handheld intraoral scanning device according to claim 1, wherein the processing unit is configured to terminate the session if integrity of the session data is corrupted.

6. A handheld intraoral scanning device according to claim 1, wherein the session data comprises a message authentication code, and wherein to verify integrity of the session data comprises to verify the message authentication code with the stored session key.

7. A handheld intraoral scanning device according to claim 1, wherein the session data comprises a digital signature, and wherein to verify integrity of the session data comprises verifying the digital signature.

8. A handheld intraoral scanning device according to claim 2, wherein the processing unit is configured to:
decrypt the session data with the session key, and
store at least part of decrypted session data in the memory unit.

9. A handheld intraoral scanning device according to claim 8, wherein the processing unit (202) is configured to terminate the session if decryption of the session data fails.

10. A handheld intraoral scanning device according to claim 1, wherein the session data comprises customization data, intraoral scanning device operating parameters and/or firmware data.

11. A handheld intraoral scanning device according to claim 1, wherein the processing unit is configured to process intraoral scan data of a patient and provide 2D image data and/or 3D image data according to the received session data.

12. A handheld intraoral scanning device according to claim 1, wherein the session key is a symmetric key.

13. A handheld intraoral scanning device according to claim 1, wherein to obtain the session key comprises to generate a random or pseudo-random number with a number generator contained in the intraoral scanning device.

14. A handheld intraoral scanning device according to claim 1, wherein the intraoral scanning device key is a symmetric key or a public key of a private-public key pair.

15. A handheld intraoral scanning device according to claim 1, wherein the processing unit is configured to send an intraoral scanning device identifier in the session response.

16. Method for communication with a handheld intraoral scanning device for acquiring intraoral scan data from a three-dimensional dental object during a scanning session comprising a processing unit configured to process intraoral scan data of a patient and provide 2D image data and/or 3D image data, a memory unit, and a wireless interface, the method comprising:
receiving a session request for a session via the wireless interface, wherein the session request includes a digital signature;
authenticating the digital signature for initiating the session;
obtaining and storing a session key;
signing the session key by an intraoral scanning device key, wherein the intraoral scanning device key is stored in a permanent memory of the intraoral scanning device;
sending a session response comprising the signed session key; and
receiving session data in the session via the wireless interface, wherein the session data corresponds to customization data for the handheld intraoral scanning device, handheld intraoral scanning device operating parameters and/or firmware data for the handheld intraoral scanning device.

17. A method according to claim 16, the method comprising verifying integrity of the session data.

18. A method according to claim 17, the method comprising terminating the session if integrity of the session data is corrupted.

19. A method according to claim 16, the method comprising:
decrypting the session data with the session key, and
storing at least part of decrypted session data in the memory unit.

20. A method according to claim 16, the method comprising verifying integrity of the session data.
